(19) United States
(12) Patent Application Publication
(10) Pub. No.: US 2013/0108210 A1
(43) Pub. Date: May 2, 2013

(54) FLEXIBLE OPTOELECTRONIC WIRING MODULE

(71) Applicants: Hiroshi UEMURA, Yokohama-shi (JP); Kentaro Kobayashi, Yokohama-shi (JP); Hideto Furuyama, Yokohama-shi (JP)

(72) Inventors: Hiroshi UEMURA, Yokohama-shi (JP); Kentaro Kobayashi, Yokohama-shi (JP); Hideto Furuyama, Yokohama-shi (JP)

(21) Appl. No.: 13/603,709

(22) Filed: Sep. 5, 2012

(30) Foreign Application Priority Data
Oct. 26, 2011 (JP) 2011-235178
Nov. 11, 2011 (JP) 2011-247282

(51) Int. Cl. G02B 6/12

(52) U.S. Cl. 385/14

(57) ABSTRACT

According to one embodiment, flexible optoelectronic wiring module includes a flexible optoelectronic wiring board of flexibility having an optical wiring path, first to third electrical wirings, an optical semiconductor element mounted on the flexible optoelectronic wiring board, electrically connected to the first electrical wiring, and optically coupled to the optical wiring path, a driving IC mounted on the flexible optoelectronic wiring board, electrically connected to the first to third electrical wirings, and a capacitor electrically connected to the third electrical wiring. The flexible optoelectronic wiring module has a circuit region on which the optical semiconductor element, the driving IC, and the capacitor are mounted.

### CROSS-REFERENCE TO RELATED APPLICATIONS

This application is based upon and claims the benefit of priority from Japanese Patent Applications No. 2011-235178, filed Oct. 26, 2011; and No. 2011-247282, filed Nov. 11, 2011, the entire contents of all of which are incorporated herein by reference.

### FIELD

Embodiments described herein relate generally to a flexible optoelectronic wiring module.

### BACKGROUND

A flexible wiring board having flexibility is used as wirings arranged in a mechanically movable portion or curved portion of an electronic apparatus. Since the performances of electronic devices such as a bipolar transistor and field effect transistor have been improved, the operation speeds of large-scale integrated circuits (LSIs) have been remarkably improved, and speed limitations and electromagnetic noise operation errors of electrical wirings used to connect them pose problems. In order to solve these problems, a flexible optoelectronic wiring module which optically wires a high-speed signal has been proposed.

### BRIEF DESCRIPTION OF THE DRAWINGS

FIG. 1A is a schematic top view of a flexible optoelectronic wiring module according to the first embodiment;

FIG. 1B is a sectional view (around a circuit region) in the wiring length direction taken along a line IB-IB in FIG. 1A;

FIG. 1C is an enlarged view around a chip capacitor in FIG. 1A;

FIG. 2 is a schematic top view of a flexible optoelectronic wiring module according to the second embodiment;

FIG. 3AA is a schematic top view of a flexible optoelectronic wiring module according to the third embodiment;

FIG. 3AB is a sectional view (around a circuit region) in the wiring length direction taken along a line IIIAB-IIIAB in FIG. 3AA;

FIG. 3BA is a schematic top view of another flexible optoelectronic wiring module according to the third embodiment;

FIG. 3BB is a sectional view (around a circuit region) in the wiring length direction taken along a line IIIBB-IIIBB in FIG. 3BA;

FIG. 4 is a schematic top view of a flexible optoelectronic wiring module according to the fourth embodiment;

FIG. 5A is a schematic plan view of a flexible optoelectronic wiring module according to the fifth embodiment;

FIG. 5B is a schematic view of the flexible optoelectronic wiring module according to the fifth embodiment;

FIG. 6A is a schematic top view of a flexible optoelectronic wiring module according to the sixth embodiment;

FIG. 6B is a sectional view in the wiring length direction taken along a line VIAB-VIAB in FIG. 6A;

FIG. 6C is an enlarged view around a frequency filter in FIG. 6A;

FIG. 7A is an enlarged view around a driving IC so as to explain a layout example of the frequency filter in FIG. 6A;

FIG. 7B is an enlarged view around a driving IC so as to explain another layout example of the frequency filter in FIG. 6A;

FIG. 7C is an enlarged view around a driving IC so as to explain still another layout example of the frequency filter in FIG. 6A;

FIG. 7D is an enlarged view around a driving IC so as to explain yet another layout example of the frequency filter in FIG. 6A;

FIG. BA is a schematic top view of a flexible optoelectronic wiring module according to the seventh embodiment;

FIG. BB is a sectional view in the wiring length direction taken along a line VIIIB-VIIIB in FIG. BA;

FIG. 9 is a schematic plan view of a flexible optoelectronic wiring module according to the eighth embodiment;

FIG. 10 is a schematic plan view of the flexible optoelectronic wiring module according to the eighth embodiment;

FIG. 11A is a schematic plan view of the flexible optoelectronic wiring module according to the eighth embodiment;

FIG. 11B is a schematic view of the flexible optoelectronic wiring module according to the eighth embodiment; and

FIG. 12 is a schematic top view of a flexible optoelectronic wiring module according to the ninth embodiment.

### DETAILED DESCRIPTION

In general, according to one embodiment, a flexible optoelectronic wiring module including a flexible optoelectronic wiring board which has flexibility and has an optical wiring path, a first electrical wiring, a second electrical wiring, and a third electrical wiring; an optical semiconductor element which is mounted on the flexible optoelectronic wiring board, is electrically connected to the first electrical wiring, and is optically coupled to the optical wiring path; a driving IC which is mounted on the flexible optoelectronic wiring board, is electrically connected to the first electrical wiring, the second electrical wiring, and the third electrical wiring, drives the optical semiconductor element via the first electrical wiring, inputs/outputs an electrical signal via the second electrical wiring, and receives a power supply potential and a ground potential via the third electrical wiring; and a capacitor which is electrically connected to the third electrical wiring. The flexible optoelectronic wiring module has a circuit region on which the optical semiconductor element, the driving IC, and the capacitor are mounted.

According to another embodiment, a flexible optoelectronic wiring module including a flexible optoelectronic wiring board which has flexibility and has an optical wiring path, a first electrical wiring, a second electrical wiring, and a third electrical wiring; an optical semiconductor element which is mounted on the flexible optoelectronic wiring board, is electrically connected to the first electrical wiring, and is optically coupled to the optical wiring path; a driving IC which is mounted on the flexible optoelectronic wiring board, is electrically connected to the first electrical wiring, the second electrical wiring, and the third electrical wiring, drives the optical semiconductor element via the first electrical wiring, inputs/outputs an electrical signal via the second electrical wiring, and receives a power supply potential and a ground potential via the third electrical wiring; a fourth electrical wiring which extends from one end to the other end of the flexible optoelectronic wiring module; and a frequency filter which is electrically connected to the fourth electrical wiring.

The flexible optoelectronic wiring module according to the embodiment can be used as, for example, a wiring module used to transmit a video signal output from an apprication processor to a display in an electronic apparatus such as a mobile phone or notebook PC.

In the flexible optoelectronic wiring module according to the embodiment, optical semiconductor elements and driving ICs for driving the optical semiconductor elements are mounted on a flexible optoelectronic wiring board having an optical wiring path and electric wirings. The flexible optoelectronic wiring module converts an electrical signal input from one end (for example, an application processor side) into an optical signal, optically transmits the converted signal, converts the optical signal into an electrical signal at the other end (for example, a display side), and outputs the electrical signal. The optical signal does not radiate any electromagnetic noise. For this reason, the flexible optoelectronic wiring module which optically transmits a signal can reduce electromagnetic noise radiation compared to a flexible wiring module which electrically transmits a signal.

The flexible optoelectronic wiring module, which can transmit the optical signal, still requires an electrical wiring (power supply wiring) used to supply electric power from one end to the other end. For this reason, when the optical semiconductor element, the driving IC, an electrical wiring used to input/output signals, and an electrical wiring used to supply electric power to the driving IC radiate electromagnetic noise, and that noise is coupled to the aforementioned power supply wiring, this power supply wiring becomes a noise source in turn, and electromagnetic noise is unwantedly radiated from the entire flexible optoelectronic wiring module.

Hence, a flexible optoelectronic wiring module according to a certain embodiment includes a capacitor to suppress electromagnetic noise radiation from an electrical wiring used to supply electric power to a driving IC and electromagnetic noise coupling to the electrical wiring such as a power supply wiring. A flexible optoelectronic wiring module according to another embodiment includes a filter to suppress conduction of noise on the electrical wiring when noise is coupled to an electrical wiring such as a power supply wiring. Thus, electromagnetic noise radiation from the flexible optoelectronic wiring module can be suppressed, and a merit of an optical wiring which does not radiate any electromagnetic noise can be maximally received.

Embodiments will be described hereinafter with reference to the drawings. In these embodiments, some practical materials and arrangements will be exemplified. However, this embodiment can be practiced using materials and arrangements having equivalent functions. Therefore, this embodiment is not limited to the following embodiments.

### [1] FIRST EMBODIMENT

A schematic arrangement of a flexible optoelectronic wiring module according to the first embodiment will be described below with reference to

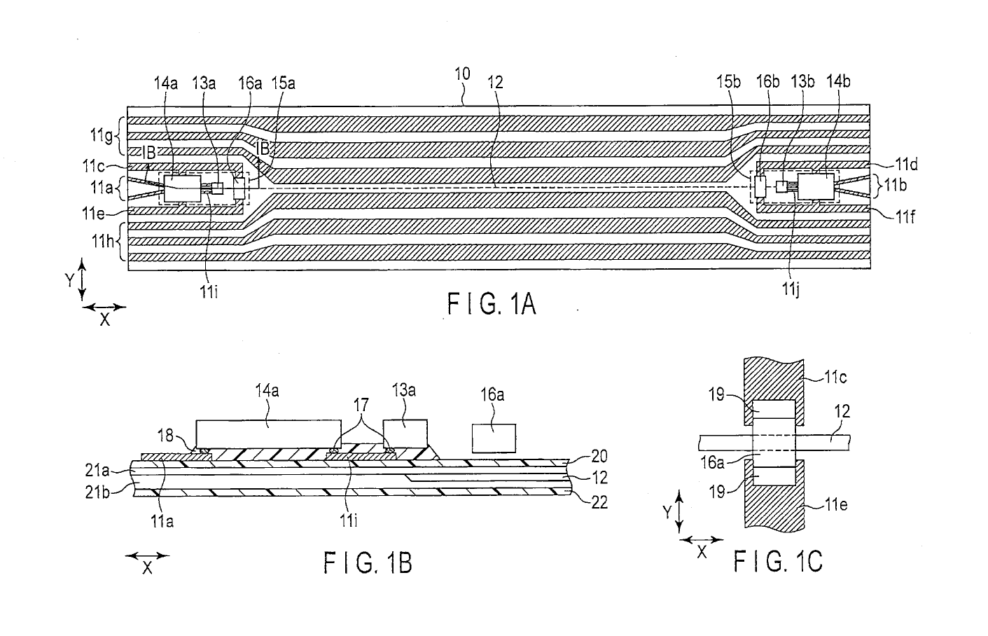

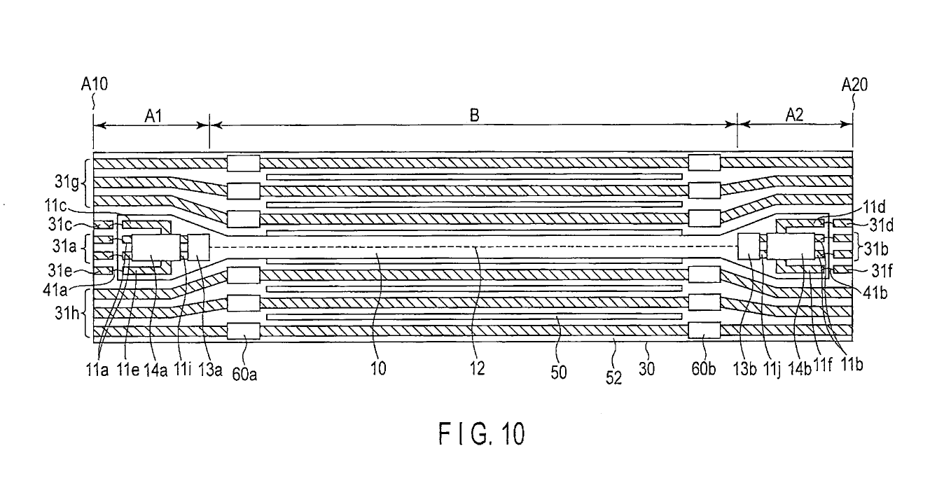

FIGS. 1A, 1B, and 10. FIG. 1A is a top view of a flexible optoelectronic wiring module, FIG. 1B is a sectional view (around a circuit region) in the wiring length direction taken along a line IB-IB in FIG. 1A, and FIG. 1C is an enlarged view around a chip capacitor.

### [1-1] Flexible Optoelectronic Wiring Module

As shown in FIG. 1A, in a flexible optoelectronic wiring module according to this embodiment, optical semiconductor elements 13 (light-emitting element 13a, light-receiving element 13b), driving ICs 14 (14a, 14b), and chip capacitors 16 (16a, 16b) are mounted on a flexible optoelectronic wiring board 10 having electrical wirings 11 (11a to 11j) and an optical wiring path (optical waveguide core) 12. The electrical wirings 11 have signal input wirings 11a, signal output wirings 11b, a power supply wiring 11c and ground wiring 11e of the driving IC 14a, a power supply wiring 11d and ground wiring 11f of the driving IC 14b, a wiring 11i used to connect the light-emitting element 13a and driving IC 14a, a wiring 11j used to connect the light-receiving element 13b and driving IC 14b, and other electrical wirings 11g and 11h. Circuit regions 15 (15a, 15b) on which the optical semiconductor elements 13, driving ICs 14, and chip capacitors 16 are mounted are located at end portion regions of the flexible optoelectronic wiring board 10.

In the flexible optoelectronic wiring module of this embodiment, the driving IC 14a drives the light-emitting element 13a according to an electrical signal input from the electrical wirings 11a, and a received photocurrent generated by the light-receiving element 13b is amplified by the driving IC 14b to output an electrical signal onto the electrical wirings 11b, thus allowing high-speed signal transmission (for example, 3 Gbps). Also, using other electrical wirings 11g and 11h, power supply and low-speed signal transmission (for example, 10 kbps) of, for example, I2C (Inter-Integrated Circuit) and SPI (Serial Peripheral Interface) from one end to the other end of the flexible optoelectronic wiring module can be made.

### [1-2] Chip Capacitor

As shown in FIG. 1A, in the flexible optoelectronic wiring module of this embodiment, the chip capacitor 16a (for example, capacitance=100 pF) is arranged between the power supply wiring 11c and ground wiring lie of the driving IC 14a, and the chip capacitor 16b (for example, capacitance=100 pF) is arranged between the power supply wiring lid and ground wiring 11f of the driving IC 14b. These chip capacitors 16a and 16b function as bypass capacitors to prevent potential fluctuations of the electrical wirings 11c and 11d and the ground wirings 11e and 11f upon operations of the driving ICs 14a and 14b, thus suppressing electromagnetic noise radiation from the electrical wirings 11c, 11d, 11e, and 11f. In this way, electromagnetic noise coupling to other electrical wirings 11g and 11h which connect one end and the other end of the flexible optoelectronic wiring module is suppressed, and electromagnetic noise radiation from the flexible optoelectronic wiring module can be greatly suppressed.

Note that the chip capacitors 16 can also be mounted on an external printed circuit board connected to the flexible optoelectronic wiring module. In this case, the functions as the bypass capacitors are considerably lowered due to parasitic impedances of the electrical wirings between the chip capacitors 16 and driving ICs 14 and those of connection members (for example, bonding wires, FPC (Flexible Printed Circuit) connectors, and ACF (Anisotropic Conductive Film)) which electrically connect the flexible optoelectronic wiring module and the printed circuit board. Hence, by mounting the chip capacitors 16 on the flexible optoelectronic wiring board 10, the electromagnetic noise radiation suppression effect can be maximized.

Each chip capacitor 16 is mounted on the side opposite to the driving IC 14 with respect to the optical semiconductor element 13. In this case, the optical semiconductor element 13, driving IC 14, and chip capacitor 16 are laid out to line up in the longitudinal direction (X direction) of the flexible optoelectronic wiring board 10. That is, the width in the Y direction of the circuit region 15 on which the optical semiconductor element 13, driving IC 14, and chip capacitor 16 are mounted (the width in a direction perpendicular to the wiring length direction of the flexible optoelectronic wiring module) is minimized. Thus, when the flexible optoelectronic wiring module is arranged inside a through hole of a movable member such as a hinge, which is popularly used in an electronic apparatus such as a mobile phone or notebook PC, the flexible optoelectronic wiring board 10 is bent or rolled in the wiring length direction, the width of the flexible optoelectronic wiring module in the Y direction can be set to be equal to that of the circuit region 15 in minimum. For this reason, the flexible optoelectronic wiring module can be arranged in a smaller through hole, thus promoting a size reduction of the electronic apparatus.

Note that each chip capacitor 16 can be mounted between the optical semiconductor element 13 and driving IC 14. However, in this case, the electrical wirings 11i and 11j which connect the optical semiconductor elements 13 and driving ICs 14 are prolonged, and electrical signals required to drive the optical semiconductor elements 13 are deteriorated to cause a signal transmission quality drop. In addition, noise radiation from these electrical wirings 11i and 11j may increase. On the other hand, the chip capacitors 16 may be mounted on the signal input wirings 11a and signal output wirings 11b. However, in this case, the characteristic impedances of the signal input wirings 11a and signal output wirings 11b may change, thus causing a signal transmission quality drop.

As shown in FIG. 1C, the chip capacitor 16a has electrical connection terminals 19 at its two ends. These electrical connection terminals 19 are mounted on the flexible optoelectronic wiring board 10 not to overlap the optical wiring path 12 when viewed from the above in a direction perpendicular to a plane of the flexible optoelectronic wiring board 10. In FIG. 1C, the electrical wirings 11c and lie are isolated in a region below the chip capacitor 16a, and the optical wiring path 12 crosses below a gap between the electrical wirings 11c and lie. Then, the electrical connection terminals 19 of the chip capacitor 16a are connected to end portions of the electrical wirings 11c and 11e, and the electrical connection terminals 19 and optical wiring path 12 do not overlap each other. Thus, when the electrical connection terminals 19 of the chip capacitor 16a are soldered to the electrical wirings 11c and 11e, the optical wiring path 12 can be prevented from being deformed or converted by heat to prevent optical losses from increasing. Note that the chip capacitor 16b of the circuit region 15b has the same arrangement as that of the chip capacitor 16a. Note that the optical wiring path 12 may cross above or below the chip capacitor 16 in FIG. 1C as long as it can be prevented from overlapping the electrical connection terminals 19 of the chip capacitor 16a. Also, when there is no fear of deformation or conversion of the optical wiring path 12 due to heat, the optical wiring path 12 and electrical connection terminals 19 may overlap.

The chip capacitor 16 is, for example, a laminated ceramic capacitor or a MLCC (Multi-Layer Ceramic Capacitor), and it is desirable to use a capacitor which has a 0603 size (length=0.6 mm, width=0.3 mm), 0402 size (length=0.4 mm, width=0.2 mm), or the like and is smaller than the optical semiconductor element 13 (for example, length=0.3 mm, width=0.3 mm) or the driving IC 14 (for example, length=0.7 mm, width 1 mm). For example, it is desirable that the width of the chip capacitor 16 in the Y direction is smaller than that of the driving IC 14 in the Y direction, so that the two end portions of the chip capacitor 16 in the Y direction are located inside those of the driving IC 14 in the Y direction.

Note that a tantalum capacitor, aluminum electrolytic capacitor, or film capacitor may be used as the chip capacitor 16. The chip capacitor 16 may be either of a two- or three-terminal type. The number of chip capacitors 16 is not limited to one per circuit region 15, but a plurality of chip capacitors may be arranged per circuit region 15. The chip capacitors 16a and 16b have the same layout with respect to the optical semiconductor elements 13 and driving ICs 14 in FIG. 10, but they may have different layouts. The two circuit regions 15a and 15b need not include the same number of chip capacitors 16, but they may include different numbers of chip capacitors 16. The capacitances, areas, and the like of the chip capacitors 16a and 16b may be equal to or different from each other.

### [1-3] Flexible Optoelectronic Wiring Board 10

As shown in FIG. 1B, the flexible optoelectronic wiring board 10 has a laminated structure prepared by laminating and adhering a base film 20 (for example, polyimide, thickness=25 μm), the electrical wirings 11 (11a to 11j) (for example, rolled Cu, thickness=12 μm), the optical wiring path (optical waveguide core) 12 (for example, thickness=30 μm), optical waveguide clads 21 (21a, 21b) (for example, total thickness=50 μm), and coverlay 22 (for example, polyimide, thickness=25 μm). The flexible optoelectronic wiring board 10 has flexibility, and has, for example, a width of 10 mm and a length of 150 mm.

### [1-4] Electrical Wiring

As shown in FIG. 1B, a Cu foil to be used as the electrical wirings 11 may be integrated with the base film 20 via an adhesive layer or may be surface-roughened and directly thermocompression-bonded on the base film 20. The electrical wirings 11 may be formed by patterning a Cu foil laminated on the base film 20 and, for example, Ni/Au (for example, thickness=5 μm/0.3 μm) may be locally plated and used as electrical connection terminals. Some of the electrical wirings 11 can be connected to the optical semiconductor elements 13 and driving IC 14 to transmit an optical signal by electrical input/output operations. Note that the patterning shapes of the electrical wirings 11 can be changed as needed. It is desirable to insulate the surfaces of the electrical wirings 11 by laminating a coverlay or photoresist except for the electrical connection terminals, lands for heat dissipation, and the like.

### [1-5] Optical Wiring

As shown in FIG. 1B, the optical waveguide core 12 and optical waveguide clads 21 are made up of a material (for example, acrylic resin or epoxy resin) which is transparent with respect to an optical transmission wavelength, and form an optical wiring layer. In order to form this optical wiring layer, the first optical waveguide clad 21a (for example, thickness=10 μm) and optical waveguide core 12 are laminated and adhered in turn on the base film 20, and the optical waveguide core 12 is patterned in correspondence with the patterning shape of the electrical wirings 11. Subsequently, the second optical waveguide clad 21b (for example, thickness=40 μm) is laminated and adhered onto the patterned optical waveguide core 12. Since the optical waveguide core 12 has a higher refractive index than each optical waveguide clad 21, light input to the optical waveguide core 12 as an optical wiring path propagates while being confined in the optical waveguide core 12.

By forming the optical wiring layer, as described above, the optical waveguide core 12 and electrical wirings 11 can be aligned with very high precision. Thus, the flexible optoelectronic wiring board 10 can assure higher alignment precision between the optical semiconductor elements 13 and optical waveguide core 12 than a compound flexible optoelectronic wiring board prepared by aligning and adhering an optical flexible wiring board and electrical flexible wiring board, which are formed separately. Furthermore, relative position variations between the optical semiconductor elements 13 and optical waveguide core 12 caused by temperature changes can be reduced, and the flexible optoelectronic wiring module with high productivity and reliability can be attained.

Note that the aforementioned optical waveguide core 12 can also be formed using a resin, the refractive index of which changes by exposure, as an optical waveguide film, and exposing a pattern on this optical waveguide film. In the aforementioned example of the optical wiring layer forming method, the electrical wirings 11 are formed first, and the optical waveguide core 12 is formed by patterning after it is aligned with the patterning shape of the electrical wirings 11. Conversely, the optical wiring layer may be formed first, and the electrical wirings 11 may be formed by patterning after they are aligned with the patterning shape of the optical waveguide core 12. Note that the number of optical waveguide cores 12 and the patterning shape can be changed as needed.

At the two ends of the optical waveguide core 12, 45° mirrors are arranged. Thus, light propagating along the optical waveguide core 12 can be output in a direction roughly perpendicular to the surface of the flexible optoelectronic wiring board 10, and light input from a direction roughly perpendicular to the surface of the flexible optoelectronic wiring board 10 can be coupled to the optical waveguide core 12. Each 45° mirror can be formed by, for example, laser ablation, dicing, press working, or the like, and a metal (for example, Au or the like) may be deposited on its mirror surface so as to improve a reflectance. Note that the angle (that with respect to a light traveling direction) of the 45° mirror need not be strictly 45°, but it is preferable to effectively fall within a range from 30° to 60°.

### [1-6] Optical Semiconductor Element

As the optical semiconductor element 13, the light-emitting element 13a or light-receiving element 13b prepared on, for example, a GaAs substrate is used, and a light-emitting or light-receiving wavelength is, for example, 850 nm. As the light-emitting element 13a, for example, a VCSEL (Vertical Cavity Surface Emitting LASER) can be used. As the light-receiving element 13b, for example, a PIN PD (Photo Diode) can be used.

The optical semiconductor element 13 is mounted using, for example, ultrasonic flip-chip bonding by aligning its light-emitting or light-receiving portion to face the 45° mirror formed on the optical waveguide core 12. Thus, the light-emitting element 13a mounted on one end side of the optical waveguide core 12 and the light-receiving element 13b mounted on the other end side are optically coupled via the optical waveguide core 12, thus allowing optical signal transmission between the one end side and the other end side of the flexible optoelectronic wiring module. The optical semiconductor elements 13 are electrically connected to the electrical wirings 11 (11i, 11j) via Au bumps 17 formed on themselves, thus allowing optical signal transmission by electrical input/output operations. As the electrical connection method, for example, bump connection using solder bumps or wire bonding connection may be used.

Note that the optical semiconductor element 13 may be formed on a substrate of a compound semiconductor (for example, GaAlAs/GaAs, InGaAs/InP, SiGe, etc.), Si, Ge, or the like. The light-emitting or light-receiving wavelength can be changed as needed. As the optical semiconductor element 13, a chip array in which a plurality of optical elements are formed within a single chip may be used, or an optical semiconductor element in which both light-emitting and light-receiving elements are formed within a single chip may be used. Furthermore, as the optical semiconductor element 13, that which can attain both light emission and light reception by a single element may be used.

In FIG. 1A, one light-emitting element 13a is mounted on one end side of the flexible optoelectronic wiring board 10, and one light-receiving element 13b is mounted on the other end side, but other optical semiconductor elements may be additionally mounted. In FIG. 1A, the transmission direction of an optical signal is a single direction from the one end side to the other end side of the flexible optoelectronic wiring board 10. Alternatively, the light-receiving element may be mounted on the one end side and the light-emitting element may be mounted on the other end side to make optical signal transmission in a direction opposite to FIG. 1A, or the light-emitting element and light-receiving element may be mounted on the one end side and the light-receiving element and light-emitting element may be mounted on the other end side to make two-way optical signal transmission.

The light-emitting element 13a as the optical semiconductor element 13 can use various kinds of light-emitting elements such as a light-emitting diode and semiconductor laser. The light-receiving element 13b as the optical semiconductor element 13 can use various kinds of light-receiving elements such as a PIN photodiode, MSM photodiode, avalanche photodiode, and photoconductor.

### [1-7] Driving IC

The driving ICs 14 are mounted on the flexible optoelectronic wiring board 10 by using, for example, ultrasonic flip-chip bonding, and are electrically connected to the electrical wirings 11 (11a, 11b) via the Au bumps 17 formed on themselves. The driving IC 14a supplies a bias current and modulation current to the light-emitting element 13a according to an electrical signal input from the electrical wirings 11a. The driving IC 14b applies a reverse biased voltage to the light-receiving element 13b, amplifies a received photocurrent generated by the light-receiving element 13b, and outputs an electrical signal onto the electrical wirings 11b. Note that the driving ICs 14 may be those (transceivers) having both functions of the driving ICs 14a and 14b. Furthermore, the driving ICs 14 may have other circuit functions (for example, a serialize function of converting a parallel electrical signal into a serial electrical signal, a deserialize function of converting a serial electrical signal into a parallel electrical signal, and the like). When the driving IC 14a for the light-emitting element 13a incorporates the serialize function, and the driving IC 14b for the light-receiving element 13b incorporates the deserialize function, a plurality of electrical input signals can be transmitted while being converted into a small number of optical signals.

### [1-8] Others

An underfill resin 18 is applied to the bottom surfaces and side surfaces of the optical semiconductor elements 13 and driving ICs 14. The underfill resin 18 is, for example, an epoxy resin, and is set by, for example, heating, ultraviolet irradiation, or the like. With the underfill resin 18, electrical connections of the electrical wirings 11, optical semiconductor elements 13, and driving ICs 14 can be held with high reliability. Gaps formed between the optical semiconductor elements 13 and optical waveguide core 12 are filled to improve optical coupling efficiency, and reflection of light by the gaps formed between the optical semiconductor elements 13 and optical waveguide core 12 can be suppressed, thus attaining highly efficient and reliable optical coupling.

Note that an underfill resin used to fill the gaps formed between the optical semiconductor elements 13 and optical waveguide core 12 and that used to hold the electrical connections of the electrical wirings 11, optical semiconductor elements 13, and driving ICs 14 may use different resins. In either case, the underfill resin used to fill the gaps formed between the optical semiconductor elements 13 and optical waveguide core 12 is desirably transparent with respect to the optical transmission wavelength.

On the second optical waveguide clad 21b, the coverlay 22 is laminated via an adhesive layer made up of, for example, an epoxy resin. With the coverlay 22, the optical wiring layer can be protected.

A polyimide reinforcing plate having, for example, a thickness of 100 μm may be further laminated on the back surfaces of the two end portions of the flexible optoelectronic wiring module including the circuit regions 15. With this plate, the flexibility of the chip mounted portions can be reduced to facilitate mounting of the optical semiconductor elements 13, driving ICs 14, and chip capacitors 16, and to prevent optical semiconductor elements 13, driving ICs 14, and chip capacitors 16 from being damaged upon bending of the flexible optoelectronic wiring board.

### [1-9] Effects

As described above, according to the first embodiment, the optical semiconductor elements 13a and 13b and the driving ICs 14a and 14b for driving the optical semiconductor elements 13a and 13b are mounted on the flexible optoelectronic wiring board 10 having the optical wiring path 12 and electrical wirings 11.

The chip capacitor 16a is electrically connected to the power supply wiring 11c and ground wiring lie of the driving IC 14a, and the chip capacitor 16b is electrically connected to the power supply wiring lid and ground wiring 11f of the driving IC 14b. Since these chip capacitors 16a and 16b function as bypass capacitors upon operations of the driving ICs 14a and 14b, they prevent potential fluctuations of the power supply wirings 11c and 11d and the ground wirings 11e and 11f and suppress electromagnetic noise radiation from the electrical wirings 11c, 11d, 11e, and 11f. Thus, electromagnetic noise coupling to other electrical wirings 11g and 11h which connect the one end and the other end of the flexible optoelectronic wiring module can be suppressed, thus suppressing electromagnetic noise radiation from the flexible optoelectronic wiring module.

According to the first embodiment, each chip capacitor 16 is mounted on the side opposite to the driving IC 14 with respect to the optical semiconductor element 13, and the chip capacitor 16, optical semiconductor element 13, and driving IC 14 are laid out to line up in the X-direction. For this reason, the width in the Y-direction of each circuit region 15 on which the optical semiconductor element 13, driving IC 14, and chip capacitor 16 are mounted can be minimized, thus promoting a size reduction of the electronic apparatus.

### [2] SECOND EMBODIMENT

The second embodiment will exemplify a case in which the length in the X-direction of each circuit region 15 is minimized compared to the first embodiment.

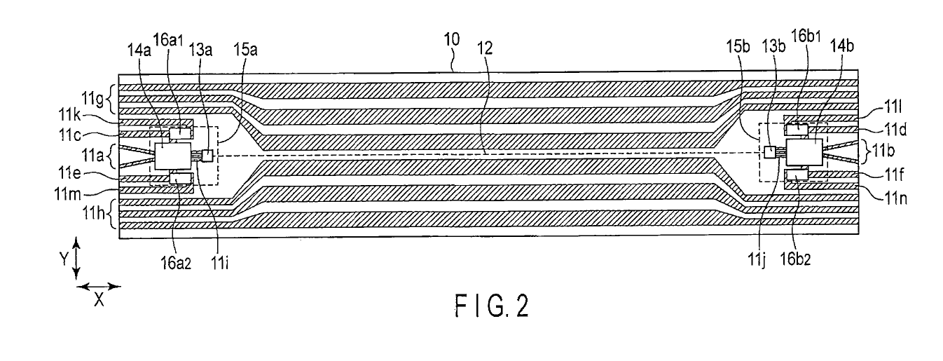

A schematic arrangement of a flexible optoelectronic wiring module according to the second embodiment will be described below with reference to FIG. 2. Note that the same reference numerals in

FIG. 2 denote the same parts as in FIG. 1A, and a detailed description thereof will not be repeated.

### [2-1] Chip Capacitor

As shown in FIG. 2, chip capacitors 16 (16a1, 16a2, 16b1, 16b2) of the second embodiment are mounted on side surface regions in the Y-direction (a direction perpendicular to the longitudinal direction of a flexible optoelectronic wiring board 10) of optical semiconductor elements 13 or driving ICs 14 to fall within the length in the X-direction of each circuit region 15. More specifically, the chip capacitors 16a1 and 16a2 are respectively laid out on the two sides in the Y-direction of the driving IC 14a in the circuit region 15a, and the chip capacitors 16b1 and 16b2 are respectively laid out on the two sides in the Y-direction of the driving IC 14b in the circuit region 15b.

In this embodiment, the chip capacitor 16a1 is electrically connected to a power supply wiring 11c of the driving IC 14a and an electrical wiring 11k, and the chip capacitor 16a2 is electrically connected to a ground wiring 11e of the driving IC 14a and an electrical wiring 11m. The chip capacitor 16b1 is electrically connected to a power supply wiring 11d of the driving IC 14b and an electrical wiring 11l, and the chip capacitor 16b2 is electrically connected to a ground wiring 11f of the driving IC 14b and an electrical wiring 11n. In this case, it is desirable to externally apply a ground potential to the electrical wirings 11k and 11l, and to externally apply a power supply potential to the electrical wirings 11m and 11n. With this structure, electromagnetic noise radiation of the flexible optoelectronic wiring module can be suppressed as in the first embodiment.

Note that the chip capacitors 16 may be laid out on the two sides in the Y-direction of the optical semiconductor elements 13. However, in order to minimize the influence of parasitic impedances of the electrical wirings used to connect the driving ICs 14 and chip capacitors 16, it is desirable to lay out the chip capacitors 16 in the vicinity of the driving ICs 14. In this case, it is desirable that the width in the X-direction of each chip capacitor 16 is smaller than that in the X-direction of the driving IC 14, and the two end portions in the X-direction of the chip capacitor 16 are located inside those in the X-direction of the driving IC 14.

The number of chip capacitors 16 in one circuit region 15 is not limited to two. Alternatively, the number of chip capacitors 16 in one circuit region 15 may be one or three or more. The two circuit regions 15a and 15b need not always include the same number of chip capacitors 16, but they may include different numbers of chip capacitors 16.

### [2-2] Effects

As described above, according to the second embodiment, as in the aforementioned first embodiment, the chip capacitor 16a1 is electrically connected to the power supply wiring 11c and ground wiring 11k, the chip capacitor 16a2 is electrically connected to the ground wiring 11e and power supply wiring 11m, the chip capacitor 16b1 is electrically connected to the power supply wiring 11d and ground wiring 11l, and the chip capacitor 16b2 is electrically connected to the ground wiring 11f and power supply wiring 11n. For this reason, the flexible optoelectronic wiring module which can suppress electromagnetic noise radiation can be provided.

Also, according to the second embodiment, the chip capacitors 16 are laid out on the side surface regions in the Y-direction of the optical semiconductor elements 13 or driving ICs 14 to fall within the length in the X-direction of each circuit region 15. For this reason, the length in the X-direction of each circuit region 15 can be minimized. Then, when the flexible optoelectronic wiring module is mounted on a circuit board in an electronic apparatus such as a mobile phone or notebook PC, the flexible optoelectronic wiring module is bent at a position closer to an end portion, thus reducing a space required to lay out the flexible optoelectronic wiring module, thereby promoting a size reduction of the electronic apparatus.

### [3] THIRD EMBODIMENT

The third embodiment will exemplify a case in which a cost reduction of a flexible optoelectronic wiring module is achieved using a flexible electrical wiring board compared to the first and second embodiments.

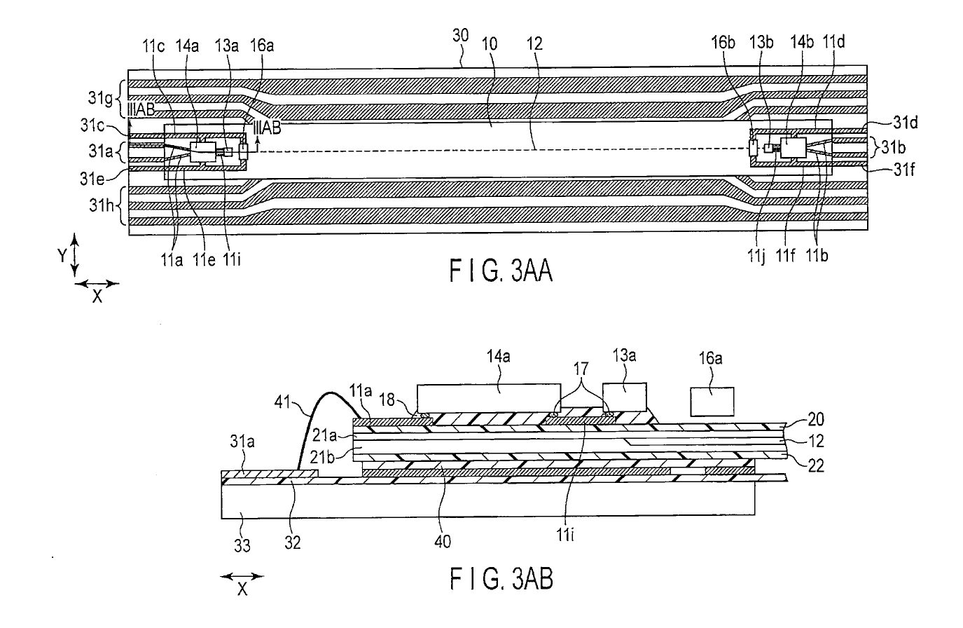

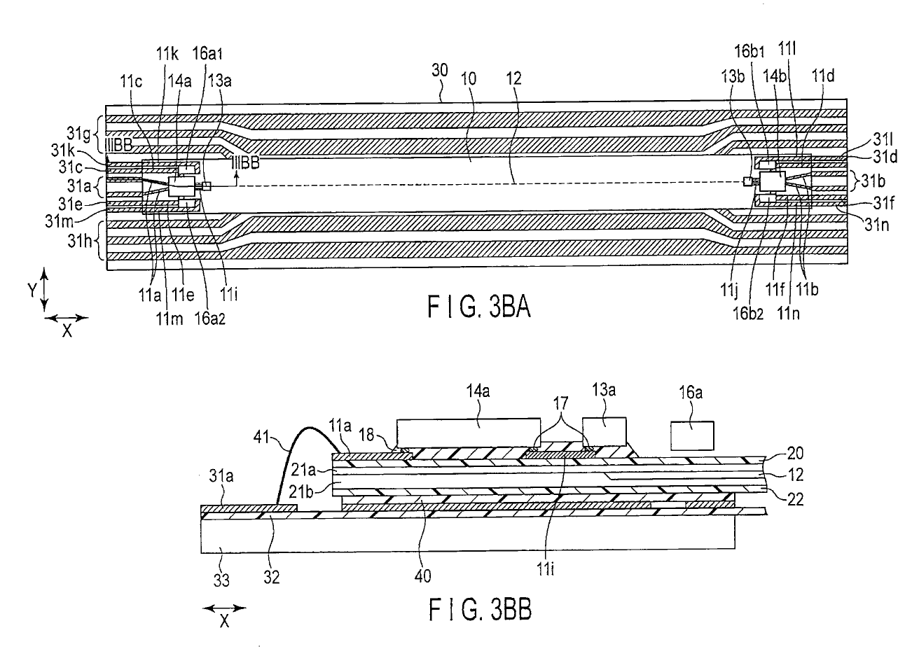

A schematic arrangement of a flexible optoelectronic wiring module according to the third embodiment will be described below with reference to FIGS. 3AA and 3AB and FIGS. 3BA and 3BB. FIGS. 3AA and 3BA are top views of the flexible optoelectronic wiring module, FIG. 3AB is a sectional view (around a circuit region) in the wiring length direction taken along a line IIIAB-IIIAB in FIG. 3AA, and FIG. 3BB is a sectional view (around a circuit region) in the wiring length direction taken along a line IIIBB-IIIBB in FIG. 3BA. Note that the same reference numerals in FIGS. 3AA and 3AB and FIGS. 3BA and 3BB denote the same parts as in FIGS. 1A, 1B, and 1C and FIG. 2, and a detailed description thereof will not be repeated.

### [3-1] Flexible Optoelectronic Wiring Module

As shown in FIGS. 3AA and 3AB and FIGS. 3BA and 3BB, in the flexible optoelectronic wiring module of the third embodiment, a flexible optoelectronic wiring board 10 (for example, width=1 mm, length=100 mm) is mounted on a flexible electrical wiring board 30 (for example, width=10 mm, length=150 mm) via an adhesive sheet 40, and electrical wirings 11 (11a to 11f, 11k to 11n) of the flexible optoelectronic wiring board 10 and electrical wirings 31 (31a to 31f, 31k to 31n) of the flexible electrical wiring board 30 are respectively electrically connected to each other via bonding wires 41.

In the flexible optoelectronic wiring module of this embodiment, high-speed signal transmission is attained by optical wirings on the flexible optoelectronic wiring board 10, and power supply and low-speed signal transmission are attained by the electrical wirings 31 on the flexible electrical wiring board 30, thus suppressing the area of the flexible optoelectronic wiring board 10 to a minimum required area. Thus, a cost reduction can be achieved compared to a case in which all electrical wirings and optical signal transmission are attained by only the flexible optoelectronic wiring board 10.

Note that in the flexible optoelectronic wiring module of this embodiment, the back surface of the flexible optoelectronic wiring board 10 is mounted on the front surface of the flexible electrical wiring board 30. Alternatively, the front surface of the flexible optoelectronic wiring board 10 may be mounted on the front surface of the flexible electrical wiring board 30, the front surface of the flexible optoelectronic wiring board 10 may be mounted on the back surface of the flexible electrical wiring board 30, or the back surface of the flexible optoelectronic wiring board 10 may be mounted on the back surface of the flexible electrical wiring board 30.

In the flexible optoelectronic wiring module of this embodiment, the bonding wires 41 are used to electrically connect the electrical wirings 11 of the flexible optoelectronic wiring board 10 and the electrical wirings 31 of the flexible electrical wiring board 30. Alternatively, the electrical wirings 11 and 31 may be connected using ink-jet wirings, stud bumps, ACF (Anisotropic Conductive Film), or ACP (Anisotropic Conductive Paste).

### [3-2] Chip Capacitor

In the third embodiment, chip capacitors 16 are mounted on the flexible optoelectronic wiring board 10 in the same manner as the first and second embodiments.

In the example shown in FIG. 3AA, as in the first embodiment, the chip capacitors 16 (16a, 16b) are mounted on the side opposite to driving ICs 14 with respect to optical semiconductor elements 13, and the optical semiconductor elements 13, driving ICs 14, and chip capacitors 16 are laid out to line up in the longitudinal direction (X-direction) of the flexible optoelectronic wiring board 10. The chip capacitor 16a is laid out at a position between a power supply wiring 11c and ground wiring 11e of the driving IC 14a, and the chip capacitor 16b is laid out at a position between a power supply wiring 11d and ground wiring 11f of the driving IC 14b. The power supply wirings 11c and lid of the flexible optoelectronic wiring board 10 are respectively electrically connected to electrical wirings 31c and 31d of the flexible electrical wiring board 30, and the ground wirings 11e and 11f of the flexible optoelectronic wiring board 10 are respectively electrically connected to electrical wirings 31e and 31f of the flexible electrical wiring board 30. For this reason, for example, a ground potential is externally applied to the electrical wirings 31e and 31f, and a power supply potential is externally applied to the electrical wirings 31c and 31d, power supply to the driving ICs 14 can be attained, and the chip capacitors 16 function as bypass capacitors.

In the example shown in FIG. 3BA, as in the second embodiment, the chip capacitors 16 (16a1, 16a2, 16b1, 16b2) are mounted on side surface regions in the Y-direction of the optical semiconductor elements 13 or driving ICs 14 to fall within the length in the X-direction of each circuit region 15. The chip capacitor 16a1 is laid out at a position between the power supply wiring 11c and a ground wiring 11k of the driving IC 14a, and the chip capacitor 16a2 is laid out at a position between a power supply wiring 11m and the ground wiring 11e of the driving IC 14a. The chip capacitor 16b1 is laid out at a position between the power supply wiring 11d and a ground wiring 11l of the driving IC 14b, and the chip capacitor 16b2 is laid out at a position between a power supply wiring 11n and the ground wiring 11f of the driving IC 14b. The power supply wirings 11c, 11d, 11m, and 11n of the flexible optoelectronic wiring board 10 are respectively electrically connected to the electrical wirings 31c, 31d, 31m, and 31n of the flexible electrical wiring board 30, and the ground wirings 11e, 11f, 11k, and 11l of the flexible optoelectronic wiring board 10 are respectively electrically connected to the electrical wirings 31e, 31f, 31k, and 31l of the flexible electrical wiring board 30. For this reason, when, for example, a ground potential is externally applied to the electrical wirings 31c, 31d, 31m, and 31n, and a power supply potential is externally applied to the electrical wirings 31c, 31d, 31m, and 31n, power supply to the driving ICs 14 can be attained, and the chip capacitors 16 function as bypass capacitors.

### [3-3] Flexible Electrical Wiring Board

As shown in FIGS. 3AB and 3BB, the flexible electrical wiring board 30 has flexibility, and includes the electrical wirings 31 (for example, rolled Cu foil, thickness=12 μm), a base film 32 (for example, polyimide, thickness=25 μm), a reinforcing plate 33 (for example, polyimide, thickness=100 μm), and the like. The flexible electrical wiring board 30 has a laminated structure prepared by laminating and adhering the electrical wirings 31, base film 32, and reinforcing plate 33, and has, for example, a width of 10 mm and a length of 150 mm.

A Cu foil to be used as the electrical wirings 31 may be integrated with the base film 32 via an adhesive layer or may be surface-roughened and directly thermocompression-bonded on the base film 32. The electrical wirings 31 may be formed by patterning a Cu foil laminated on the base film 32 and, for example, Ni/Au (for example, thickness=5 μm/0.3 μm) may be locally plated and used as electrical connection terminals. Note that the patterning shapes of the electrical wirings 31 can be changed as needed. It is desirable to insulate the surfaces of the electrical wirings 31 by laminating a coverlay or photoresist except for the electrical connection terminals, lands for heat dissipation, and the like.

The adhesive sheet 40 adheres and fixes the flexible optoelectronic wiring board 10 and flexible electrical wiring board 30. As the adhesive sheet 40 to be used, for example, an adhesive of an epoxy resin, acrylic resin, polyester resin, or the like may be shaped into a sheet shape, or adhesive layers of the aforementioned adhesive may be formed on both the surfaces of a base material made up of a resin film of polyimide or the like or a metal foil of Al, Cu, or the like. The thickness of the adhesive sheet 40 is, for example, 50 μm. Note that in FIGS. 3AB and 3BB, the adhesive sheet 40 is arranged in the vicinity of a portion where the optical semiconductor element 13 and driving IC 14 are mounted, which portion is located at each of the two ends of the flexible optoelectronic wiring board 10. Alternatively, a single adhesive sheet extending from one end to the other end of the flexible optoelectronic wiring board may be used. In place of using the adhesive sheet 40, for example, flexible optoelectronic wiring board 10 may be fixed to the flexible electrical wiring board 30 using, for example, a mold resin.

### [3-4] Effects

As described above, in the third embodiment, the chip capacitors 16 are mounted at positions between the power supply wirings and ground wirings of the driving ICs 14 as in the first and second embodiments. For this reason, electromagnetic noise radiation of the flexible optoelectronic wiring module can be suppressed.

In the third embodiment, the length in the X-direction (in case of FIGS. 3BA and 3BB) or the width in the Y-direction (in case of FIGS. 3AA and 3AB) of each circuit region on which the optical semiconductor element 13, driving IC 14, and chip capacitor 16 are mounted can be minimized, thus promoting a size reduction of the electronic apparatus, as in the aforementioned first and second embodiments.

In the third embodiment, high-speed signal transmission is attained by optical wirings of the flexible optoelectronic wiring board 10, and power supply and low-speed signal transmission are attained by the electrical wirings 31 of the flexible electrical wiring board 30. Thus, since the area of the flexible optoelectronic wiring board 10 can be suppressed to a minimum required area, a cost reduction can be attained compared to a case in which all of electrical wirings and optical signal transmission are attained by only the flexible optoelectronic wiring board 10.

### [4] FOURTH EMBODIMENT

The fourth embodiment can avoid an optical wiring path from being damaged by a heating process compared to the third embodiment since chip capacitors 16 are mounted on a flexible electrical wiring board 30.

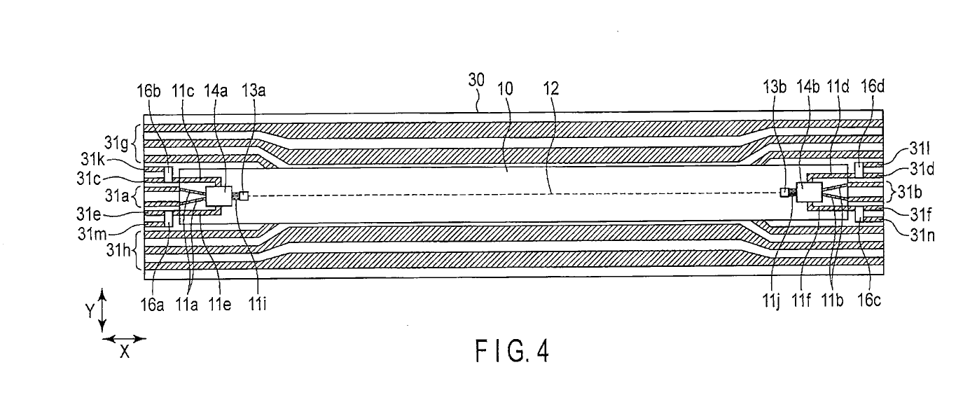

A schematic arrangement of a flexible optoelectronic wiring module according to the fourth embodiment will be described below with reference to FIG. 4. Note that the same reference numerals in FIG. 4 denote the same parts as in FIGS. 3AA and 3BA, and a detailed description thereof will not be repeated.

### [4-1] Chip Capacitor

As shown in FIG. 4, in the flexible optoelectronic wiring module of the fourth embodiment, the chip capacitors 16 are mounted on the flexible electrical wiring board 30 unlike in the third embodiment.

Electrical wirings 11 (11a to 11f) of a flexible optoelectronic wiring board 10 are respectively electrically connected to electrical wirings 31 (31a to 31f) of the flexible electrical wiring board 30 via, for example, bonding wires. Thus, a power supply wiring 11c of a driving IC 14a is electrically connected to a chip capacitor 16a1, a ground wiring lie of the driving IC 14a is electrically connected to a chip capacitor 16a2, a power supply wiring 11d of a driving IC 14b is electrically connected to a chip capacitor 16b1, and a ground wiring 11f of the driving IC 14b is electrically connected to a chip capacitor 16b2. For this reason, it is desirable to externally apply, for example, a ground potential to electrical wirings 31e, 31f, 31k, and 31l, and to externally apply, for example, a power supply potential to electrical wirings 31c, 31d, 31m, and 31n. Then, power supply to the driving ICs 14 can be attained, the chip capacitor 16a1 is laid out at a position between the power supply wiring 31c and ground wiring 31k, the chip capacitor 16a2 is laid out at a position between the power supply wiring 31m and ground wiring 31e, the chip capacitor 16b1 is laid out at a position between the power supply wiring 31d and ground wiring 311, the chip capacitor 16b2 is laid out at a position between the power supply wiring 31n and ground wiring 31f, and the chip capacitors 16 function as bypass capacitors.

Note that in this embodiment, the chip capacitors 16 are mounted on the flexible electrical wiring board 30. In this case, the chip capacitors 16 are desirably laid out in the vicinity (for example, within 5 mm) of the driving ICs 14.

### [4-2] Effects

As described above, in the fourth embodiment, the chip capacitors 16 are mounted between the power supply wirings and ground wirings as in the aforementioned first to third embodiments. For this reason, electromagnetic noise radiation of the flexible optoelectronic wiring module can be suppressed.

In the fourth embodiment, the chip capacitors 16 are mounted on the flexible electrical wiring board 30. For this reason, before the flexible optoelectronic wiring board 10 is mounted on the flexible electrical wiring board 30, the chip capacitors 16 can be soldered to the flexible electrical wiring board 30 by a soldering reflow process. Then, damages on an optical wiring path 12 can be prevented. For example, optical losses can be prevented from being increased due to deformation or conversion of an optical wiring path 12 due to heat in the soldering reflow process.

In the fourth embodiment, since the chip capacitors 16 are mounted on the flexible electrical wiring board 30, the area of the flexible optoelectronic wiring board 10 can be suppressed to a minimum required area, thus allowing a cost reduction.

### [5] FIFTH EMBODIMENT

The fifth embodiment will exemplify a case in which bendability or twistability of a wiring region of a flexible optoelectronic wiring module is improved.

A schematic arrangement of a flexible optoelectronic wiring module according to the fifth embodiment will be described below with reference to

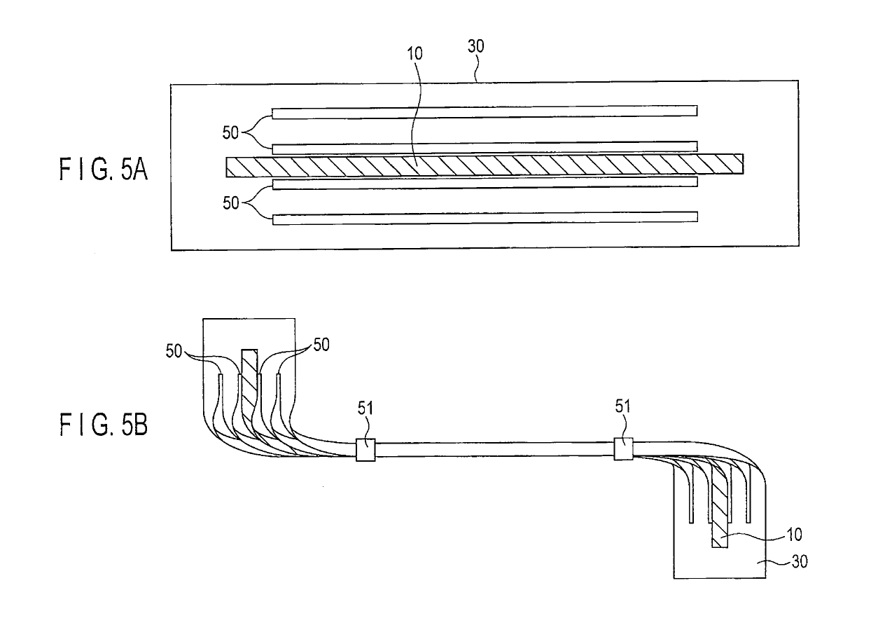

FIGS. 5A and 5B. Note that FIGS. 5A and 5B show only outer shapes of a flexible optoelectronic wiring board 10 and flexible electrical wiring board 30, and do not illustrate other portions. However, as a practical arrangement, the arrangements of the aforementioned embodiments can be applied.

As shown in FIG. 5A, in the flexible optoelectronic wiring module of the fifth embodiment, through slits 50 (for example, width=0.1 mm) parallel to the wiring direction of the flexible electrical wiring board 30 are formed to divide a wiring region of the flexible electrical wiring board 30 into a plurality of thin lines (for example, width=1 mm), and the flexible optoelectronic wiring board 10 is mounted on one divided thin line.

As shown in FIG. 5B, in the flexible optoelectronic wiring module shown in FIG. 5A, one end portion region, wiring region, and the other end portion region of the flexible optoelectronic wiring module are laid out to form a crank shape, the plurality of thin lines are overlaid so that front and back surfaces of neighboring thin lines face each other, and the plurality of thin lines are bundled using bands 51. In this manner, the flexible optoelectronic wiring module can be handled as a thin flexible wiring board having a bundle of the wiring region. For this reason, this flexible optoelectronic wiring module can cope with a turning operation, twisting operation, and the like in addition to a bending operation.

It is desirable to set the widths and intervals of all the thin lines to be nearly equal to each other. Thus, when the flexible optoelectronic wiring module is bundled, as described above, a tension can be prevented from concentrating on some thin lines. Since all of the plurality of thin lines are equivalently strained, the plurality of thin lines are aligned well in regions where the plurality of thin lines are bundled, and some thin lines can be prevented from being separated. Note that the thin lines of the flexible optoelectronic wiring module may be overlaid by another method (for example, the plurality of thin lines are overlaid so that front and front surfaces or back and back surfaces of the neighboring thin lines face each other).

As the bands 51, a seal tape of, for example, a fluorine resin can be used. It is desirable to use a tape without any adhesive as the bands 51 so that the respective thin lines are movable inside the bands 51. Thus, slacks and stresses of the thin lines can be removed. Note that the number of bands 51 can be changed as needed. In place of separate bands, for example, a continuous band extending from one end to the other end of the thin line bundle may be used. When there is no fear of separation of a bundle of the plurality of thin lines or these thin lines are allowed to be separated, the bands 51 need not be used. It is desirable not to form any electrical wirings on portions where the through slits 50 are formed.

The entire surface of the flexible optoelectronic wiring board 10 may be adhered to the flexible electrical wiring board 30, or only regions in the vicinity of its end portions may be adhered to the flexible electrical wiring board 30. Also, a thin line of the flexible electrical wiring board 30 where the flexible optoelectronic wiring board 10 is laid out may be removed. In this case, the flexible optoelectronic wiring board 10 need not overlap the flexible electrical wiring board 30 on the wiring region, and a minimum bending radius upon bending or sliding motions of the wiring region of the flexible optoelectronic wiring module can be reduced. Furthermore, a friction between the flexible optoelectronic wiring board 10 and flexible electrical wiring board 30 can be eliminated, thus improving durability against repetitive bending and sliding motions.

The aforementioned embodiments can be variously changed. For example, an FPC, FFC (Flexible Flat Cable), or the like is applicable to the flexible electrical wiring board 30. As a base film of the flexible electrical wiring board 30 and flexible optoelectronic wiring board 10, a liquid crystal polymer and other resins can be used in addition to polyimide. The electrical wirings 31 of the flexible electrical wiring board 30 may have either a single- or multi-layered structure. The electrical wirings 11 and optical wiring layer of the flexible optoelectronic wiring board 10 may have either a single- or multi-layered structure.

### [6] SIXTH EMBODIMENT

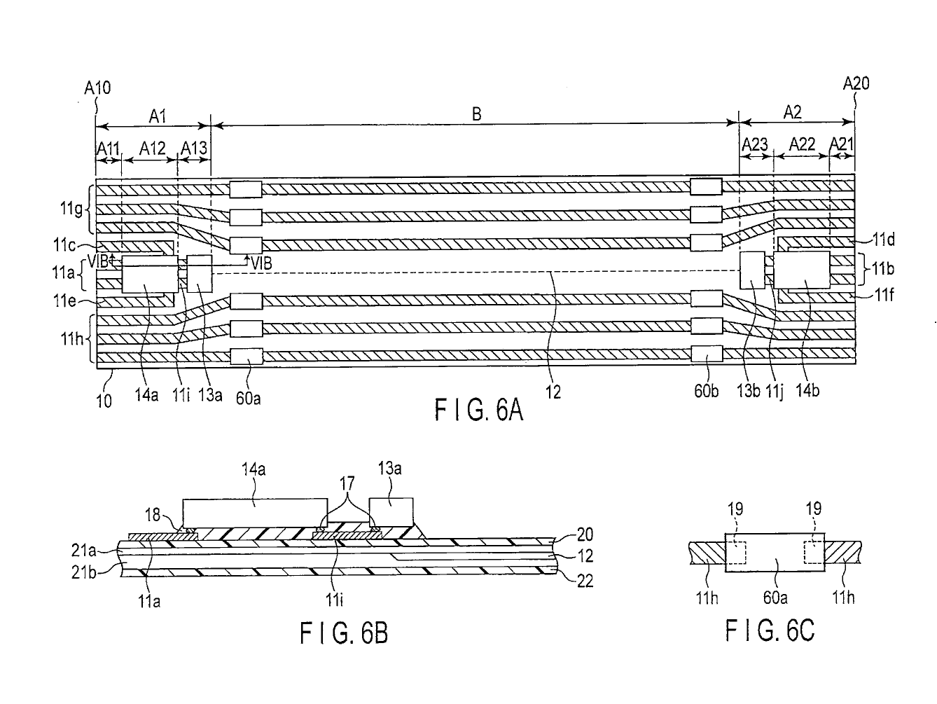

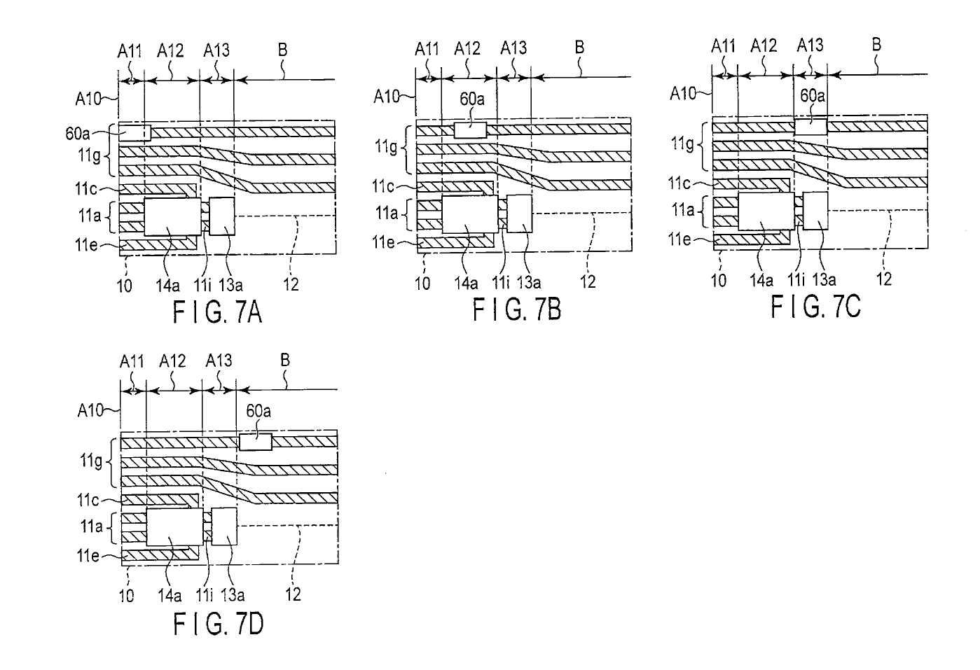

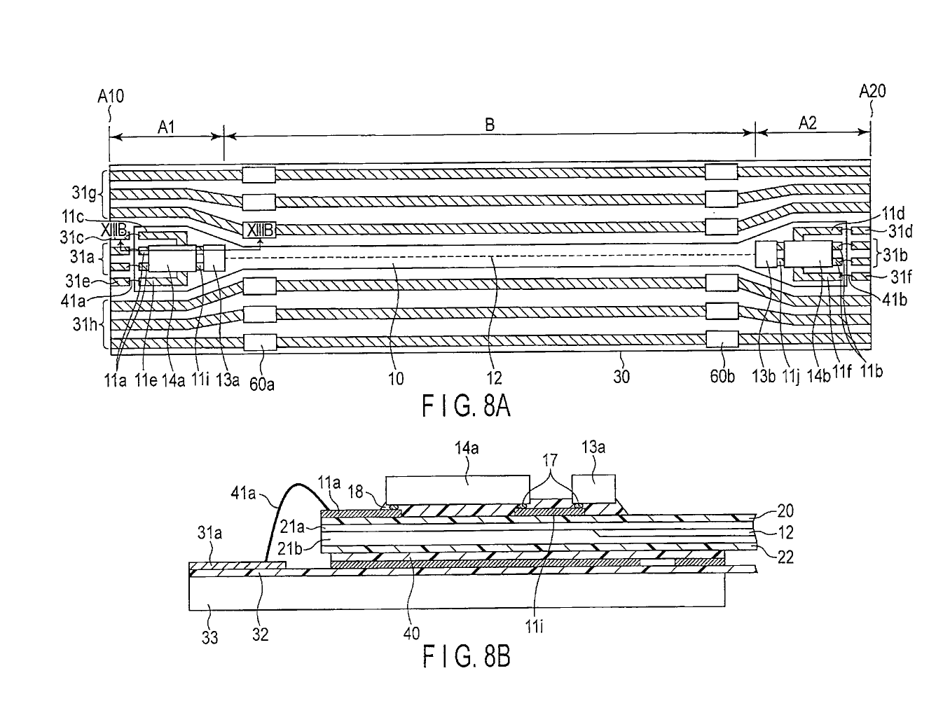

It is different from the first to fourth embodiments that the sixth embodiment suppresses electromagnetic noise radiation using frequency filter. A schematic structure of a flexible optoelectronic wiring module according to the sixth embodiment will be described below with reference to FIGS. 6A, 6B, and 6C and FIGS. 7A, 7B, 7C, and 7D. FIG. 6A is a top view of the flexible optoelectronic wiring module, FIG. 6B is a sectional view in the wiring length direction taken along a VIB-VIB line of FIG. 6A, and FIG. 6C is an enlarged view around a frequency filter. FIGS. 7A, 7B, 7C, and 7D are enlarged views around a driving IC so as to explain layout examples of the frequency filter. Note that the same reference numerals in FIGS. 6A, 6B, 6C, 7A, 7B, 7C and 7D denote the same parts as in FIGS. 1A, 1B and 1C, and a detailed description thereof will not be repeated.

### [6-1] Flexible Optoelectronic Wiring Module

As shown in FIG. 6A, in the flexible optoelectronic wiring module of the sixth embodiment, optical semiconductor elements 13 (light-emitting element 13a, light-receiving element 13b), driving ICs 14 (14a, 14b), and frequency filters 60 (60a, 60b) are mounted on a flexible optoelectronic wiring board 10 having electrical wirings 11 (11a to 11j) and an optical wiring path (optical waveguide core) 12. The electrical wirings 11 have signal input wirings 11a, signal output wirings 11b, a power supply wiring 11c and ground wiring 11e of the driving IC 14a, a power supply wiring 11d and ground wiring 11f of the driving IC 14b, a wiring 11i used to connect the light-emitting element 13a and driving IC 14a, a wiring 11j used to connect the light-receiving element 13b and driving IC 14b, and other electrical wirings 11g and 11h, which extend from one end to the other end of the flexible optoelectronic wiring board 10. Regions where the optical semiconductor elements 13 and driving ICs 14 are mounted are located on a pair of end portion regions A (A1, A2) which are spaced apart in the wiring length direction, and a wiring region B is arranged between these end portion regions A.

### [6-2] Frequency Filter

In the flexible optoelectronic wiring module of the sixth embodiment, the frequency filters 60 (60a, 60b) are electrically connected to the electrical wirings 11g and 11h. Each frequency filter 60 includes a chip ferrite bead, chip capacitor, chip inductor, or their combinations.

The chip ferrite bead mainly has an inductance component and a resistance component as a circuit parameter. In a high frequency region, the resistance component becomes the main component, and it can change a noise into heat and can absorb it. In a high frequency region, since impedance rises, the chip inductor can cut off a high frequency noise. The chip capacitor is preventing the potential shake of electric wiring, and can control radiation of a noise. Moreover, in a high frequency region, since impedance falls, it is possible by bypassing the high frequency noise of an input to another electric wiring to cut a high frequency noise. The noise inputted from the outside of the flexible optoelectronic wiring board 10 and the noise generated inside the flexible optoelectronic wiring board 10 are able to control conducting to the wiring region B by these frequency filters 60. In addition, these frequency filters 60 can form by chip components which have sizes, such as 1005 (1.0 mm long, 0.5 mm wide) and 0603 (0.6 mm long, 0.3 mm wide), for example.

As shown in FIG. 6A and FIGS. 7A, 7B, 7C, and 7D, the end portion regions A1 and A2 are separated into input/output regions A11 and A21, driving IC regions A12 and A22, and optical element regions A13 and A23.

Effects obtained when the frequency filter 60a (60b) is laid out on the input/output region A11 (A21), driving IC region A12 (A22), optical element region A13 (A23), and wiring region B, respectively, will be described below with reference to FIGS. 7A, 7B, 7C, and 7D. Note that on which of the input/output regions A11 and A21, driving IC regions A12 and A22, optical element regions A13 and A23, and wiring region B the frequency filters 60a and 60b are located is desirably judged based on a position of a side surface facing an end A10 side on the end portion region A1 side of the flexible optoelectronic wiring board 10 in case of the frequency filter 60a and based on a position of a side surface facing an end A20 side on the end portion region A2 side of the flexible optoelectronic wiring board 10 in case of the frequency filter 60b.

FIG. 7A shows a case in which the frequency filter 60a is mounted on the input/output region A11. In FIG. 7A, the side surface on the end A10 side of the flexible optoelectronic wiring board 10 of side surfaces of the frequency filter 60a is located to be closer to the end A10 side of the flexible optoelectronic wiring board 10 than that on the end A10 side of the flexible optoelectronic wiring board 10 of side surfaces of the driving IC 14a. In this case, noise directly input from an external circuit connected to the flexible optoelectronic wiring board 10 and noise generated in a connection portion (for example, an FPC connector connection portion) between the flexible optoelectronic wiring board 10 and an external circuit can be suppressed from being transmitted to the wiring region B. Also, some noise components generated from the input/output region A11 can be suppressed from being coupled to the wiring region B.

FIG. 7B shows a case in which the frequency filter 60a is mounted on the driving IC region A12. In FIG. 7B, the frequency filter 60a is laid out on a side surface region of the driving IC 14a in a direction perpendicular to the wiring length direction. The side surface on the end A10 side of the flexible optoelectronic wiring board 10 of the side surfaces of the frequency filter 60a is located to be closer to the end A20 side of the flexible optoelectronic wiring board 10 than the side surface on the end A10 side of the flexible optoelectronic wiring board 10 of the side surfaces of the driving IC 14a, and is located to be closer to the end A10 side of the flexible optoelectronic wiring board 10 than the side surface on the end A20 side of the flexible optoelectronic wiring board 10 of the side surfaces of the driving IC 14a. In this case, in addition to the effects when the frequency filter 60a is mounted on the input/output region A11, noise generated from the input/output region A11 can be effectively suppressed from being coupled to the wiring region B. Also, some noise components generated from the driving IC 14a can be suppressed from being coupled to the wiring region B.

FIG. 7C shows a case in which the frequency filter 60a is mounted on the optical element region A13. In FIG. 7C, the frequency filter 60a is laid out on a side surface region of the optical semiconductor element 13a in a direction perpendicular to the wiring length direction. The side surface on the end A10 side of the flexible optoelectronic wiring board 10 of the side surfaces of the frequency filter 60a is located to be closer to the end A20 side of the flexible optoelectronic wiring board 10 than the side surface on the end A20 side of the flexible optoelectronic wiring board 10 of the side surfaces of the driving IC 14a, and is located to be closer to the end A10 side of the flexible optoelectronic wiring board 10 than a side surface on the end A20 side of the flexible optoelectronic wiring board 10 of side surfaces of the optical semiconductor element 13a. In this case, in addition to the effects obtained when the frequency filter 60a is mounted on the driving IC region A12, noise generated from the driving IC region A12 can be effectively suppressed from being coupled to the wiring region B. Also, some noise components generated from the optical semiconductor element 13a and electrical wiring 11i can be suppressed from being coupled to the wiring region B.

FIG. 7D shows a case in which the frequency filter 60a is mounted on the wiring region B. In FIG. 7D, the side surface on the end A10 side of the flexible optoelectronic wiring board 10 of the side surfaces of the frequency filter 60a is located to be closer to the end A20 side of the flexible optoelectronic wiring board 10 than the side surface on the end A20 side of the flexible optoelectronic wiring board 10 of the side surfaces of the optical semiconductor element 13a. In this case, in addition to the effects obtained when the frequency filter 60a is mounted on the optical element region A13, noise generated from the optical element region A13 can be effectively prevented from being coupled to the wiring region B.

In this case, on the wiring region B, the frequency filters 60a and 60b can be laid out at arbitrary positions in the wiring length direction on the electrical wirings 11g and 11h. However, when the frequency filters 60a and 60b are laid out to be separated farther away from the end portion regions A1 and A2, electromagnetic noise is often also radiated from regions between the end portion regions A1 and A2 and frequency filters 60a and 60b of the electrical wirings 11g and 11h. Therefore, when the frequency filters 60a and 60b are laid out within the wiring region B and at positions in the vicinity of the end portion regions A1 and A2, the effect of suppressing electromagnetic noise radiation can be maximally received. That is, it is desirable to lay out the frequency filter 60a on an end portion on the end portion region A1 side in the wiring region B, and to lay out the frequency filter 60b on an end portion on the end portion region A2 side in the wiring region B. The side surface on the end A10 (A20) side of the flexible optoelectronic wiring board 10 of the side surfaces of the frequency filter 60a (60b) may be flush with the side surface on the end A20 (A10) side of the flexible optoelectronic wiring board 10 of the side surfaces of the optical semiconductor elements 13a and 13b.

Note that in FIGS. 7A, 7B, 7C, and 70, only one frequency filter 60a is mounted on the plurality of electrical wirings 11g. However, the embodiment is not limited to this. For example, the frequency filters 60a or 60b may be mounted on all electrical wirings of the electrical wirings 11g or 11h one by one, or two or more frequency filters 60a or 60b may be mounted on one of the electrical wirings 11g or 11h. Also, the frequency filters 60a and 60b may be laid out at symmetric positions or at different positions between the end portion regions A1 and A2. The numbers, sizes, shapes, types, and the like of frequency filters 60a and 60b to be mounted may be the same or different between the end portion regions A1 and A2.

When the frequency filter 60a is a frequency filter which mainly has the inductor component and cuts off a noise, such as the chip ferrite bead and the chip inductor, inserting in series against electric wiring is desirable. In this case, as shown in FIG. 6C, the frequency filter 60a is arranged on the divided region of the electrical wiring 11h. It is to be desired that the frequency filter 60a is connected to the electrical wiring 11h through the electrical connection terminals 19. The width (it is perpendicular width against the orientation of wiring length of the electrical wiring 11h) of the frequency filter 60a may be large, and may be the same or smaller than the width of the electrical wiring 11h. When the frequency filter 60a is a frequency filter which becomes mainly capacitor and cuts off noise rejection, such as a chip capacitor, it is to be desired that the frequency filter 60a is connected between different two electrical wirings among the electrical wiring 11h.

### [6-3] Others

A polyimide reinforcing plate having, for example, a thickness of 100 μm may be further laminated on the back surfaces of the two end portions of the flexible optoelectronic wiring module including the regions on which the optical semiconductor elements 13, driving ICs 14 and the frequency filter 60 are mounted. With this plate, the flexibility of the chip mounted portions can be reduced to facilitate mounting of the optical semiconductor elements 13, driving ICs 14 and the frequency filter 60, and to prevent optical semiconductor elements 13, driving ICs 14 and the frequency filter 60 from being damaged upon bending of the flexible optoelectronic wiring board.

### [6-4] Effects

As described above, according to the sixth embodiment, the optical semiconductor elements 13a and 13b and the driving ICs 14a and 14b for driving the optical semiconductor elements 13a and 13b are mounted on the flexible optoelectronic wiring board 10 having the optical wiring path 12 and electrical wirings 11, and the frequency filters 60 are electrically connected to the electrical wirings 11g and 11h. With this structure, electromagnetic noise which is generated upon operations of the optical semiconductor elements 13a and 13b and driving ICs 14a and 14b in the end portion regions A1 and A2 and is coupled to the electrical wirings 11g and 11h can be suppressed from being transmitted to the electrical wirings 11g and 11h in the wiring region B. For this reason, electromagnetic noise radiation from the entire flexible optoelectronic wiring module can be greatly suppressed.

### SEVENTH EMBODIMENT

The seventh embodiment will exemplify a case in which a cost reduction of a flexible optoelectronic wiring module is achieved using a flexible electrical wiring board as the second embodiment, compared to the sixth embodiment.

A schematic arrangement of a flexible optoelectronic wiring module according to the seventh embodiment will be described below with reference to FIGS. 8A and 8B. FIG. 8A is a top view of the flexible optoelectronic wiring module, and FIG. 8B is a sectional view in the wiring length direction taken along a line VIIIB-VIIIB in FIG. 8A. Note that the same reference numerals in FIGS. 8A and 8B denote the same parts as in FIGS. 3AA, 3AB, 3BA, 3BB, 6A, 6B, and 6C, and a detailed description thereof will not be repeated.

### [7-1] Flexible Optoelectronic Wiring Module

As shown in FIGS. 8A and 8B, in the flexible optoelectronic wiring module of the seventh embodiment, a flexible optoelectronic wiring board 10 (for example, width=1 mm, length=100 mm) is mounted on a flexible electrical wiring board 30 (for example, width=10 mm, length=150 mm) via an adhesive sheet 40, and electrical wirings 11 (11a to 11f) of the flexible optoelectronic wiring board 10 and electrical wirings 31 (31a to 31f) of the flexible electrical wiring board 30 are respectively electrically connected via bonding wires 41 (41a, 41b). Circuit portions on which optical semiconductor elements 13a and 13b and driving ICs 14a and 14b of the flexible optoelectronic wiring board 10 are mounted are laid out on end portion regions A1 and A2.

In the flexible optoelectronic wiring module of this embodiment, the area of the flexible optoelectronic wiring board 10 is suppressed to a minimum required area, and power supply and some low-speed signal transmission operations are attained by the electrical wirings 31 on the flexible electrical wiring board 30, thus attaining a cost reduction compared to the sixth embodiment. Although not shown in FIGS. 8A and 8B, electrical wirings (corresponding to the electrical wirings 11g and 11h in FIG. 6A) extending from one end to the other end of the flexible optoelectronic wiring board 10 may be arranged to execute power supply and some low-speed signal transmission operations. In this case, it is desirable to insert frequency filters in these electrical wirings.

### [7-2] Frequency Filter

As shown in FIG. 8A, in this embodiment, frequency filters 60a and 60b are electrically connected to electrical wirings 31g and 31h mounted on the flexible electrical wiring board 30. The frequency filter 60a is laid out at an end portion in a wiring region B on the end portion region A1 side, and the frequency filter 60b is laid out at an end portion in the wiring region B on the end portion region A2 side.

Note that the layout positions, numbers, shapes, sizes, and the like of the frequency filters 60a and 60b of the seventh embodiment can be variously changed as in the sixth embodiment.

### [7-3] Effects

As described above, in the seventh embodiment, the frequency filters 60a and 60b are electrically connected to the electrical wirings 31a and 31h as in the aforementioned sixth embodiment. For this reason, electromagnetic noise radiation of the flexible optoelectronic wiring module can be suppressed.

Furthermore, in the seventh embodiment, the area of the flexible optoelectronic wiring board 10 is suppressed to a minimum required area, and power supply and low-speed signal transmission are attained by the electrical wirings 31 of the flexible electrical wiring board 30, thus allowing a cost reduction compared to the sixth embodiment.

### EIGHTH EMBODIMENT

The eighth embodiment will exemplify a case in which bendability or twistability of a wiring region B of a flexible optoelectronic wiring module is improved, and a reliability drop caused by overlapping of frequency filters 60a and 60b is suppressed.

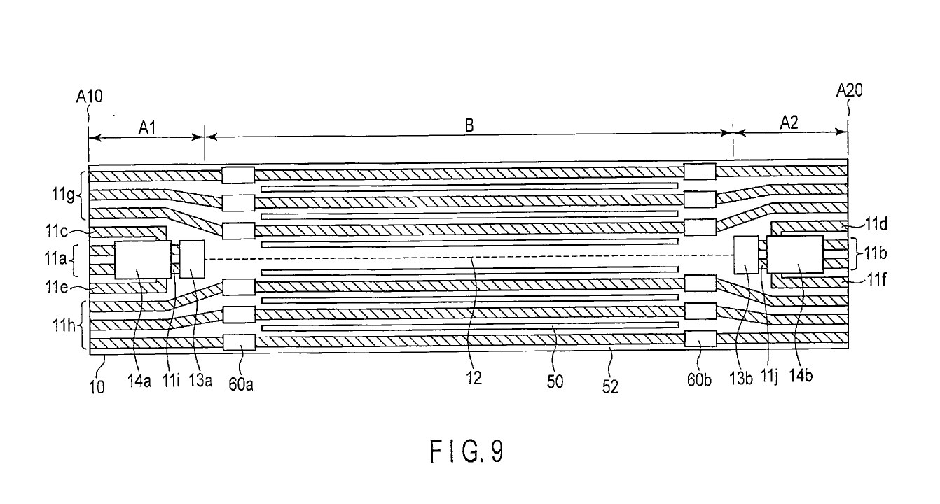

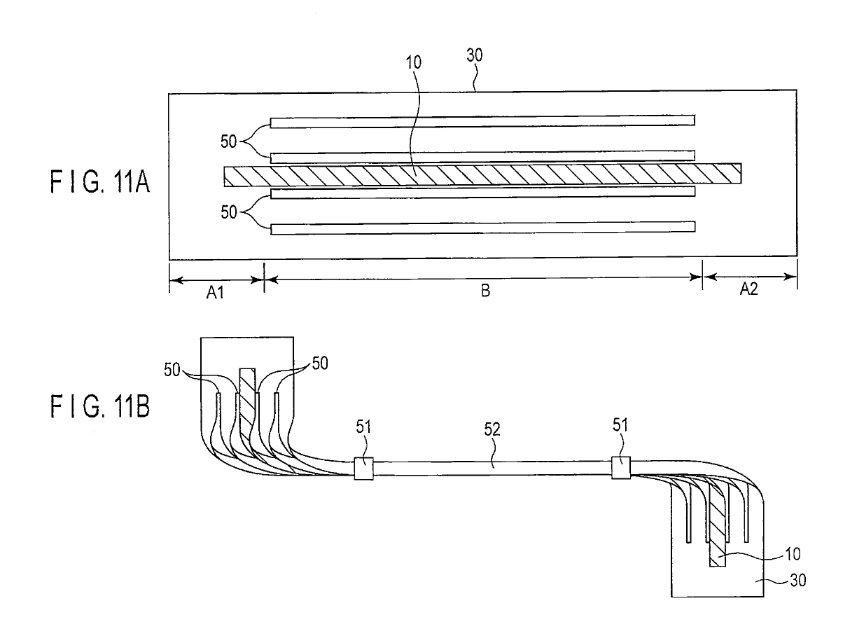

A schematic arrangement of a flexible optoelectronic wiring module according to the eighth embodiment will be described below with reference to FIGS. 9, 10, 11A, and 11B. FIGS. 9 and 10 are top views of the flexible optoelectronic wiring module. Note that FIGS. 11A and 11B show only outer shapes of a flexible optoelectronic wiring board 10 and flexible electrical wiring board 30, and do not illustrate other portions. However, as a practical arrangement, the arrangements of other embodiments can be applied.

### [8-1] Flexible Optoelectronic Wiring Module

As shown in FIGS. 9 and 10, in the flexible optoelectronic wiring module of the eighth embodiment, at least one through slit 50 (for example, width=0.1 mm) parallel to the wiring length direction of the flexible optoelectronic wiring board 10 or flexible electrical wiring board 30 is formed to divide a wiring region B of the flexible optoelectronic wiring board 10 or flexible electrical wiring board 30 into a plurality of wiring fins 52 (thin lines) (for example, width=1 mm).

In the example of FIG. 9, the through slits 50 are formed on the flexible optoelectronic wiring board 10 and are located at positions between frequency filters 60a and 60b. That is, the through slits 50 are located to be closer to the central portion side of the flexible optoelectronic wiring board 10 than the frequency filters 60a and 60b. The frequency filters 60a and 60b are laid out between the wiring fins 52 of the flexible optoelectronic wiring board 10 and end portion regions A1 and A2 of the flexible optoelectronic wiring board 10.

In the example of FIG. 10, the through slits 50 are formed on the flexible electrical wiring board 30, and are located at positions between the frequency filters 60a and 60b. That is, the through slits 50 are located to be closer to the central portion side of the flexible electrical wiring board 30 than the frequency filters 60a and 60b. The flexible optoelectronic wiring board 10 is mounted on one divided wiring fin 52 on the flexible electrical wiring board 30. The frequency filters 60a and 60b are laid out between the wiring fins 52 of the flexible electrical wiring board 30 and end portion regions A1 and A2 of the flexible electrical wiring board 30.

As shown in FIG. 11B, in the flexible optoelectronic wiring module shown in FIGS. 9 and 10, one end portion region A1, wiring region B, and the other end portion region A2 of the flexible optoelectronic wiring module are laid out to form a crank shape, the plurality of wiring fins 52 are overlaid so that front and back surfaces of neighboring wiring fins 52 face each other, and the plurality of wiring fins 52 can be bundled using bands 51. In this case, the bands 51 are located to be closer to the central portion side of the flexible optoelectronic wiring module than the frequency filters 60a and 60b. In this manner, the flexible optoelectronic wiring module can be handled as a thin flexible wiring board having a bundle of the wiring region B. For this reason, this flexible optoelectronic wiring module can cope with a turning operation, twisting operation, and the like in addition to a bending operation.

Note that FIGS. 11A and 11B show only outer shapes and through slits 50 of the flexible optoelectronic wiring board 10 and flexible electrical wiring board 30 in order to explain simply. FIGS. 11A and 11B show the flexible optoelectronic wiring module (corresponding to the flexible optoelectronic wiring module of FIG. 10) which mounts the flexible optoelectronic wiring board 10 in the flexible electrical wiring board 30.

However, even if it is the flexible optoelectronic wiring module (corresponding to the flexible optoelectronic wiring module of FIG. 9) which formed the through slits 50 in the flexible optoelectronic wiring board 10, as shown in FIG. 11B, the wiring fin 52 can be bundled in layers.

### [8-2] Effects

As described above, in the eighth embodiment, the frequency filters 60a and 60b are electrically connected to the electrical wirings 11a and 11h or 31a and 31h as in the aforementioned sixth and seventh embodiments. For this reason, electromagnetic noise radiation of the flexible optoelectronic wiring module can be suppressed.

In the eighth embodiment shown in FIG. 10, since the area of the flexible optoelectronic wiring board 10 is suppressed to a minimum required area, a cost reduction can be attained compared to a case in which all of electrical wirings and optical signal transmission are attained by only the flexible optoelectronic wiring board 10.

In the eighth embodiment, the frequency filters 60a and 60b connected to the electrical wirings 11a and 11h or 31a and 31h are laid out between the wiring fins 52 and the end portion regions A1 and A2. Then, when the wiring fins 52 of the flexible optoelectronic wiring module are stacked and bundled, as shown in FIG. 11B, since the bands 51 are arranged to be closer to the central portion side of the flexible optoelectronic wiring module than the frequency filters 60a and 60b, the frequency filters 60a and 60b never overlap each other. For this reason, occurrence of unnecessary frictions of the flexible optoelectronic wiring module and short-circuiting between different electrical wirings via the frequency filters 60a and 60b can be prevented.

### NINTH EMBODIMENT

The ninth embodiment will exemplify a case in which a plurality of frequency filters 60 are laid out to be alternately shifted.

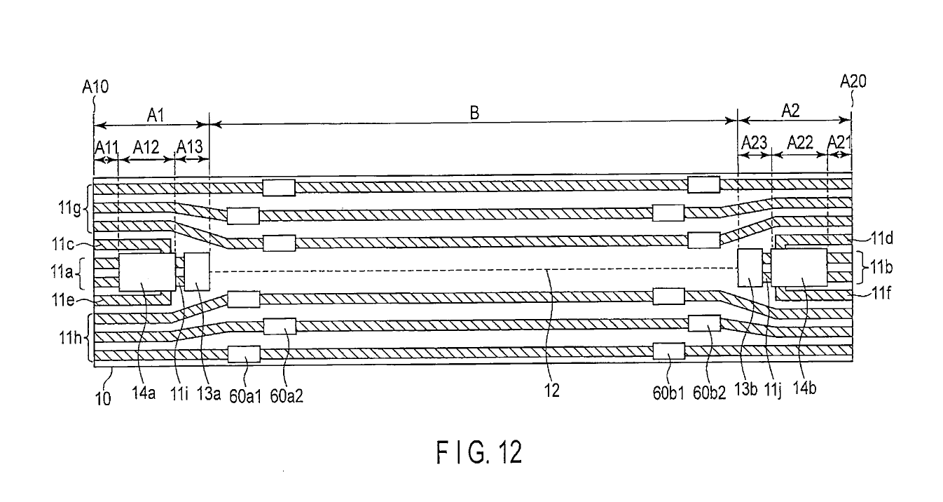

A schematic arrangement of a flexible optoelectronic wiring module according to the ninth embodiment will be described below with reference to FIG. 12. Note that the same reference numerals in FIG. 12 denote the same parts as in FIG. 6A, and a detailed description thereof will not be repeated.

### [9-1] Frequency Filter

As shown in FIG. 12, in the ninth embodiment, frequency filters 60a1 and 60a2 connected to electrical wirings 11g and 11h, which neighbor vertically (in a direction perpendicular to the wiring length direction), are arranged to be alternately shifted horizontally (in the wiring length direction) (so as not to be aligned in the direction perpendicular to the wiring length direction) on a left end portion in a wiring region B. Likewise, frequency filters 60b1 and 60b2 connected to the vertically neighboring electrical wirings 11g and 11h are arranged to be alternately shifted horizontally (so as not to be aligned in the direction perpendicular to the wiring length direction) on a right end portion in the wiring region B.

Note that in FIG. 12, the positional relationship between the frequency filters 60a1 and 60a2 in the wiring length direction may be reversed, and that between the frequency filters 60b1 and 60b2 in the wiring length direction may be reversed. Also, the frequency filters 60a1, 60a2, 60b1, and 60b2 need not always be laid out in the wiring region B, but they may be laid out in input/output regions A11 and A21, driving IC regions A12 and A22, or optical element regions A13 and A23. In the ninth embodiment, a flexible electrical wiring board 30 may be used like in the seventh embodiment, or through slits 50 may be formed like in the eighth embodiment.

### [9-2] Effects

As described above, in the ninth embodiment, the frequency filters 60a1, 60a2, 60b1, and 60b2 are electrically connected to the electrical wirings 11a and 11h. For this reason, electromagnetic noise radiation of the flexible optoelectronic wiring module can be suppressed.

In the ninth embodiment, the frequency filters 60a1, 60a2, 60b1, and 60b2 connected to the neighboring electrical wirings 11g and 11h are laid out to be alternately shifted. For this reason, when the flexible optoelectronic wiring board 10 is rolled up into a cylindrical shape having the wiring length direction as an axis, or when wiring fins 52 divided by through slits 50 are bundled like in the eighth embodiment, the frequency filters 60a1, 60a2, 60b1, and 60b2 can be suppressed from interfering with each other by twisting the flexible optoelectronic wiring board 10.

The aforementioned embodiments can be variously changed. For example, an FPC, FFC (Flexible Flat Cable), or the like is applicable to the flexible electrical wiring board 30. As a base film of the flexible electrical wiring board 30 and flexible optoelectronic wiring board 10, a liquid crystal polymer and other resins can be used in addition to polyimide. The electrical wirings 31 of the flexible electrical wiring board 30 may have either a single- or multi-layered structure. The electrical wirings 11 and optical wiring layer of the flexible optoelectronic wiring board 10 may have either a single- or multi-layered structure.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A flexible optoelectronic wiring module comprising:
a flexible optoelectronic wiring board which has flexibility and has an optical wiring path, a first electrical wiring, a second electrical wiring, and a third electrical wiring;
an optical semiconductor element which is mounted on the flexible optoelectronic wiring board, is electrically connected to the first electrical wiring, and is optically coupled to the optical wiring path;
a driving IC which is mounted on the flexible optoelectronic wiring board, is electrically connected to the first electrical wiring, the second electrical wiring, and the third electrical wiring, drives the optical semiconductor element via the first electrical wiring, inputs/outputs an electrical signal via the second electrical wiring, and receives a power supply potential and a ground potential via the third electrical wiring; and
a capacitor which is electrically connected to the third electrical wiring,
wherein the flexible optoelectronic wiring module has a circuit region on which the optical semiconductor element, the driving IC, and the capacitor are mounted.

2. The module according to claim 1, further comprising a flexible electrical wiring board having flexibility and having a fourth electrical wiring and a fifth electrical wiring,
wherein the capacitor is mounted on the flexible optoelectronic wiring board,
the fourth electrical wiring is electrically connected to the second electrical wiring, and
the fifth electrical wiring is electrically connected to the third electrical wiring.

3. The module according to claim 1, wherein the capacitor is mounted on the flexible optoelectronic wiring board,
the optical semiconductor element, the driving IC, and the capacitor line up in a longitudinal direction of the flexible optoelectronic wiring board,
the capacitor is laid out on a side opposite to the driving IC with respect to the optical semiconductor element in the circuit region, and
an electrical connection terminal of the capacitor does not overlap the optical wiring path when viewed from above in a direction perpendicular to a plane of the flexible optoelectronic wiring board.

4. The module according to claim 1, wherein the capacitor is mounted on the flexible optoelectronic wiring board,
the optical semiconductor element and the driving IC line up in a longitudinal direction of the flexible optoelectronic wiring board, and
the capacitor is laid out on a region in a direction perpendicular to the longitudinal direction of the flexible optoelectronic wiring board with respect to the optical semiconductor element or the driving IC.

5. The module according to claim 1, further comprising a flexible electrical wiring board having flexibility and having a fourth electrical wiring and a fifth electrical wiring,
wherein the capacitor is mounted on the flexible electrical wiring board,
the fourth electrical wiring is electrically connected to the second electrical wiring, and
the fifth electrical wiring is electrically connected to the third electrical wiring.

6. The module according to claim 1, wherein a pair of end portion regions which are spaced apart in a wiring length direction of the fourth electrical wiring and a wiring region sandwiched between the end portion regions are formed on the flexible optoelectronic wiring board or the flexible electrical wiring board, and
the wiring region is divided into a plurality of wiring fins by at least one through slit.

7. A flexible optoelectronic wiring module comprising:
a flexible optoelectronic wiring board which has flexibility and has an optical wiring path, a first electrical wiring, a second electrical wiring, and a third electrical wiring;
an optical semiconductor element which is mounted on the flexible optoelectronic wiring board, is electrically connected to the first electrical wiring, and is optically coupled to the optical wiring path;
a driving IC which is mounted on the flexible optoelectronic wiring board, is electrically connected to the first electrical wiring, the second electrical wiring, and the third electrical wiring, drives the optical semiconductor element via the first electrical wiring, inputs/outputs an electrical signal via the second electrical wiring, and receives a power supply potential and a ground potential via the third electrical wiring;
a fourth electrical wiring which extends from one end to the other end of the flexible optoelectronic wiring module; and
a frequency filter which is electrically connected to the fourth electrical wiring.

8. The module according to claim 7, further comprising a flexible electrical wiring board which has flexibility and has a fifth electrical wiring electrically connected to the second electrical wiring, and a sixth electrical wiring electrically connected to the third electrical wiring,
wherein the fourth electrical wiring and the frequency filter are mounted on the flexible electrical wiring board.

9. The module according to claim 7, further comprising a flexible electrical wiring board which has flexibility and has a fifth electrical wiring electrically connected to the second electrical wiring, a sixth electrical wiring electrically connected to the third electrical wiring, and a seventh electrical wiring electrically connected to the fourth electrical wiring,
wherein the fourth electrical wiring is mounted on the flexible optoelectronic wiring board, and
the frequency filter is electrically connected to the fourth electrical wiring of the flexible optoelectronic wiring board or the seventh electrical wiring of the flexible electrical wiring board.

10. The module according to claim 7, wherein a pair of end portion regions which are spaced apart in a wiring length direction of the fourth electrical wiring and a wiring region sandwiched between the end portion regions are formed on the flexible optoelectronic wiring board or the flexible electrical wiring board,
the wiring region is divided into a plurality of wiring fins by at least one through slit, and
the frequency filter is mounted on the end portion regions.

11. The module according to claim 7, wherein a side surface on a side opposite to the wiring region side of side surfaces of the frequency filter is laid out on a region on a side surface side of the optical semiconductor element in a direction perpendicular to a wiring length direction of the fourth electrical wiring of side surfaces of the optical semiconductor element.

12. The module according to claim 7, wherein a side surface on a side opposite to the wiring region side of side surfaces of the frequency filter is located to be closer to the wiring region side than a side surface on the wiring region side of side surfaces of the optical semiconductor element.

13. The module according to claim 7, wherein the frequency filter includes a plurality of frequency filters, and
two different frequency filters of the plurality of frequency filters are arranged not to be aligned in a direction perpendicular to a wiring length direction of the fourth electrical wiring.
